(19) United States
(12) Patent Application Publication
(10) Pub. No.: US 2014/0226180 A1
(43) Pub. Date: Aug. 14, 2014

(54) PORTABLE COPIER AND PRINTER

(71) Applicant: Bennie Alex, Chicago, IL (US)

(72) Inventor: Bennie Alex, Chicago, IL (US)

(21) Appl. No.: 14/165,822

(22) Filed: Jan. 28, 2014

Related U.S. Application Data
(60) Provisional application No. 61/763,999, filed on Feb. 13, 2013.

(51) Int. Cl. H04N 1/23; H04N 1/00

(52) U.S. Cl. CPC H04N 1/23; H04N 1/00278
USPC 358/1.15

(57) ABSTRACT

A portable printer for storage, printing and copying functions that includes: a housing; a storage compartment within the housing, where the storage compartment stores and distributes a plurality of sheets of paper for use in the portable printer; a window on the housing, where the window receives an object for copying; a lid pivotally attached to the housing, where the lid covers the window; and a touch screen on the lid, where the touch screen provides an interactive mechanism to control functions related to the portable printer.

### CROSS REFERENCE TO OTHER APPLICATIONS

This application claims priority to U.S. Provisional Application Ser. No. 61/763,999 filed on Feb. 13, 2013.

### BACKGROUND OF THE INVENTION

1. Field of the Invention

The present invention relates to a compact, portable printer.

2. Description of Related Art

Portability is a key concept with electronics today. Laptop computers are continuously available in the lightest, smallest, most portable body structure. To provide an even more compact computing option tablets have been developed as a screen with touch screen capabilities able to withstand most computing needs. Cellular phones or smart phones also serve as small computing devices able to fit in a purse, pocket or handbag.

Even with these great portable computing options printing and copying options are still home, office or retail based. The user is limited where they print and copy based upon whether they have the required devices at their home or office. If not, they are required to make the trip to a copy center where they must pay for each page printed or copied. It would be desirable in the art to provide a printer that is portable to allow for printing in any location desired by the user. It would also be beneficial in the art for the portable printer to include copying options along with the printing in a single portable device.

### SUMMARY OF THE INVENTION

The present invention relates to a portable printer for storage, printing and copying functions that includes: a housing; a storage compartment within the housing, where the storage compartment stores and distributes a plurality of sheets of paper for use in the portable printer; a window on the housing, where the window receives an object for copying; a lid pivotally attached to the housing, where the lid covers the window; and a touch screen on the lid, where the touch screen provides an interactive mechanism to control functions related to the portable printer.

### BRIEF DESCRIPTION OF THE DRAWINGS

The advantages and features of the present invention will become better understood with reference to the following detailed description and claims taken in conjunction with the accompanying drawing and in which:

FIG. 1 depicts a perspective view of a portable printer in accordance with an exemplary embodiment of the present invention; and

FIG. 2 depicts a top view of a portable printer in accordance with an exemplary embodiment of the present invention.

### DETAILED DESCRIPTION OF THE DRAWINGS

The present invention relates to a personal, compact printer. The invention provides a portable printer to store, print and copy files as needed in any location. The portable printer includes a touch screen to operate the function of the printer, and a storage space to hold paper ready for copying and printing. The portable printer is a storage device with printing functions, to serve as an all-in-one media handling device.

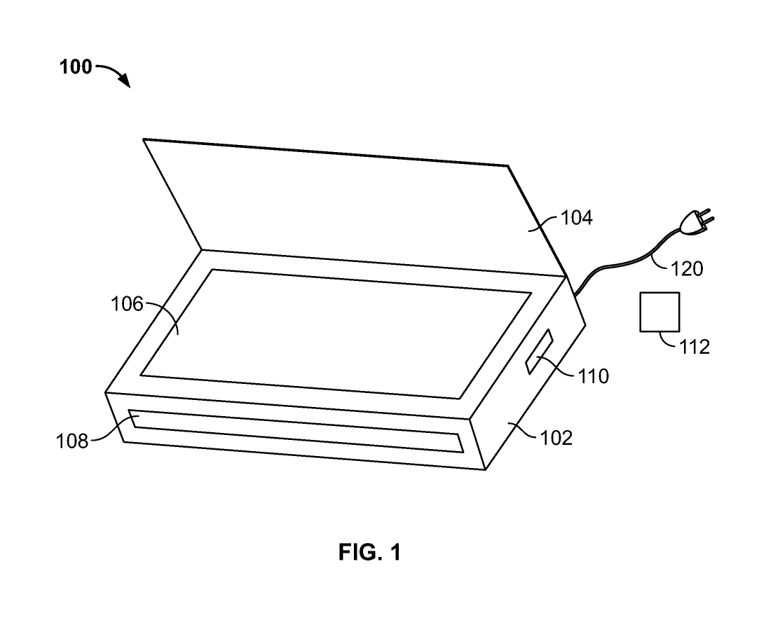

Turning now descriptively to the drawing, referring to FIG. 1, a perspective view of a portable printer 100 is shown in accordance with an exemplary embodiment of the present invention. The portable printer 100 includes a housing 102 that comprises a generally cubed shape. The housing 102 may be 12 inches long, 9 inches wide and 1.25 inches deep. Size differentiation is available preferably sizes to accommodate standard paper size of 8½ inches by 11 inches. Alternatively, a small housing 102 may be available to allow for photo printing allowing for a standard photo size of 4 inches by 6 inches.

The housing 102 includes a lid 104 pivotally attached to a back edge of the housing 102. The lid 104 covers a window 106 where the window 106 is used for copying purposes. During use, the user simply places the object or paper they wish to copy on the window 106, places the lid 104 over the object and then copies the object using the portable printer 100. The paper may be stored in a storage compartment 108 positioned within the housing 102. From the storage compartment 108 is also where the papers are expelled after the portable printer 100 copies or prints.

On the side of the housing 102 is a slot 110 to receive a memory card 112. The slot 110 and memory card 112 enable the portable printer 100 to print files from external data sources. Files for printing may also be sent to the housing through a wireless connection such as Bluetooth® or infrared technology. This wireless connection enables files on a computer, laptop or smart phone may be printed on the portable printer 100. The housing 102 includes a rechargeable battery (not shown), which may be charged via a 120-volt outlet by connecting a power cord 120.

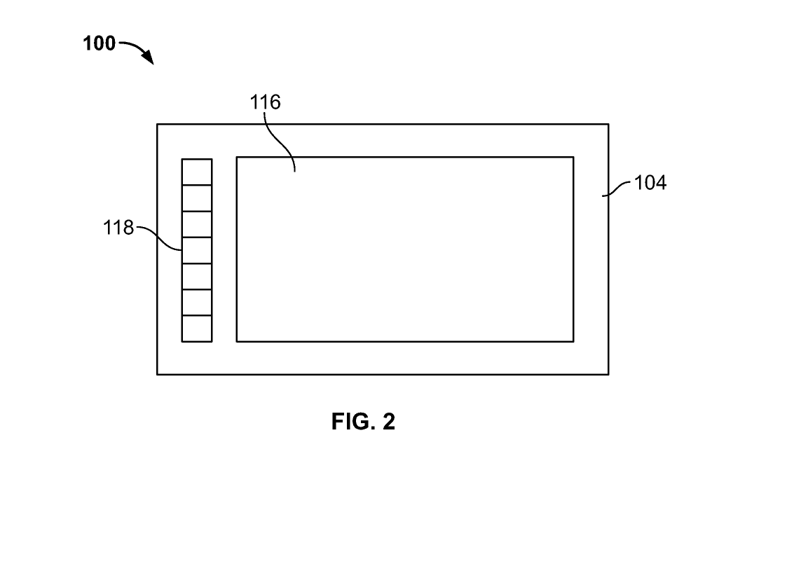

Referring now to FIG. 2 a top view of the portable printer 100 is shown in accordance with an exemplary embodiment of the present invention. A touch screen 116 placed on the lid 104, where the touch screen 116 may be centrally positioned on the lid 104. The touch screen 116 provides an interactive mechanism to enable the user to enter commands related to printing, storage and copying options available with the portable printer 100. A keypad 118 may be positioned on the lid 104 next to the touch screen 118. The keypad 118 may provide activation controls for the portable printer 100.

With the compact size of the portable printer a user may easily slip it into their bag or briefcase to have storage, printing and copying options wherever they go. The portable printer is approximately the size of a laptop so portability is very convenient for individuals on the go.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The exemplary embodiment was chosen and described in order to best explain the principles of the invention and its practical application, to thereby enable others skilled in the art to best utilize the invention and various embodiments with various modifications as are suited to the particular use contemplated.

What is claimed is:

1. A portable printer for storage, printing and copying functions comprising:
a. a housing;
b. a storage compartment within the housing, where the storage compartment stores and distributes a plurality of sheets of paper for use in the portable printer;
c. a window on the housing, where the window receives an object for copying;
d. a lid pivotally attached to the housing, where the lid covers the window; and
e. a touch screen on the lid, where the touch screen provides an interactive mechanism to control functions related to the portable printer.

2. The portable printer according to claim 1, further including a keypad positioned on the lid next to the touch screen wherein the keypad provides activation controls for the portable printer.

3. The portable printer according to claim 1, where the housing include a slot to receive a memory card.

4. The portable printer according to claim 1, further including a wireless connection where the wireless connection provides a mechanism to receive files for printing.

5. The portable printer according to claim 4, where the wireless connection includes at least one of a Bluetooth connection or an infrared connection.

6. The portable printer according to claim 1, where the housing includes a rechargeable battery.
